(19) United States
(12) Patent Application Publication
(10) Pub. No.: US 2026/0244389 A1
(43) Pub. Date: Aug. 20, 2026

(54) MULTI-DISPLAY TERMINAL CAPABLE OF REAL-TIME SCREEN SWITCHING AND METHOD THEREOF

(71) Applicant: TELECHIPS INC., Seongnam-si (KR)

(72) Inventors: Gyuhwan KIM, Seongnam-si (KR); Sungwon LEE, Seongnam-si (KR)

(21) Appl. No.: 19/459,692

(22) Filed: Jan. 26, 2026

(30) Foreign Application Priority Data
Feb. 14, 2025 (KR) 10-2025-0019730

(51) Int. Cl. G06F 3/14; G06F 3/153; G06T 1/20

(52) U.S. Cl. CPC G06F 3/1446; G06F 3/153; G06T 1/20; G06T 2200/24; G06T 2200/28

(57) ABSTRACT

A method for operating a multi-display terminal equipped with a plurality of screens comprises replacing a pipeline by interchanging at least a portion of the properties between the target screens using properties of the target screens, in response to a screen switching request based on a user input; and applying property change information on the replaced pipeline to the target screens.

### CROSS-REFERENCE TO RELATED APPLICATION

This application claims priority under 35 U.S.C. § 119(a) to Korean Patent Application No. 10-2025-0019730 filed in the Korean Intellectual Property Office on Feb. 14, 2025, the entire contents of which are incorporated herein by reference.

### BACKGROUND

### (a) Field

The present disclosure relates to a multi-display terminal capable of real-time screen switching and method thereof.

### (b) Description of the Related Art

Pipeline changes are an advanced task requiring close communication and coordination between hardware (H/W) and software (S/W) in a display terminal configured to output display data.

The Direct Rendering Manager (DRM) is a hardware interface connecting a display device and graphic data, and each pipeline is statically allocated to a specific display device. That is, a conventional DRM design is configured to output image data generated by each application only to a specific display device. To change this, components of the DRM, such as a plane, a cathode ray tube controller (CRTC), an encoder, a connector, and others must be reconfigured.

For the reconfiguration, a state of the existing pipeline must be released, and then a newly created configuration must be applied to the released pipeline. During this process, display latency or interruption may occur.

When a pipeline change request occurs in real time, the kernel must immediately process the change, but this may lead to high computational complexity and hardware resource contention issues.

Meanwhile, there is a trend toward an increasing number of in-vehicle display devices and diversification of information that can be displayed. Accordingly, a driver may obtain various information, such as speed, destination information, audio/video (AV), climate control, and so on, through multiple display devices.

Even with diverse display screens, the driver can acquire information only when the vehicle is stopped or in limited situations, and the display screens that can actually be viewed while driving are limited. Therefore, the driver may need different screens depending on driving conditions, such as while driving or in a stopped state, and accordingly, information to be displayed on a screen close to the driver's view may also vary.

However, as described above, conventional technology has a limitation in that an application can utilize only one pipeline, and thus image data can be displayed only on a designated display device.

### SUMMARY

The present disclosure provides a multi-display terminal capable of real-time screen switching, and a method thereof.

A method for operating a multi-display terminal equipped with a plurality of screen according to some embodiments of the present disclosure comprises: replacing a pipeline by interchanging at least a portion of properties between target screens using the properties of the target screens, in response to a screen switching request based on a user input; and applying property change information on the replaced pipeline to the target screens.

The replacing the pipeline may comprise changing properties of a cathode ray tube controller (CRTC) and a connector of a kernel for a first screen to properties of a CRTC and a connector of the kernel for a second screen, and changing properties of the CRTC and the connector for the second screen to properties of the CRTC and the connector for the first screen.

The method may further comprise: prior to the replacing the pipeline, collecting and storing properties for a screen of each pipeline from a plurality of display applications coupled to the plurality of screens via respective independent pipelines.

The replacing the pipeline and the collecting and storing of the properties may be performed by a framework application positioned between the plurality of display applications and the kernel.

The replacing the pipeline may comprise providing, by the framework application, properties of target pipelines for switching to a pipeline switching application having detected the screen switching request, in response to a request from the pipeline switching application; receiving, by the framework application, processed properties from the pipeline switching application; and replacing the pipeline based on the processed properties.

A multi-display terminal according to some embodiments comprises: at least one display device configured to output a plurality of screens; a memory configured to store instructions; and a processor configured to execute the instructions to provide: a kernel configured to process image data to be output to the plurality of screens; a plurality of display applications coupled to the plurality of screens via respective independent pipelines, wherein each of the plurality of display applications is configured to generate a property including a display setting for a corresponding screen and output the property to the kernel; and a framework application positioned between the kernel and the plurality of display applications, wherein the framework application is configured to: perform a pipeline replacement by interchanging at least a portion of properties between target screens using the properties of the target screens, in response to a screen switching request based on a user input; and apply property change information on the replaced pipeline to the target screens.

The processor of the multi-display terminal may be further configured to execute the instructions to provide a pipeline switching application. The pipeline switching application is configured to: detect the screen switching request; receive, from the framework application, properties of target pipelines for the screen switching and process the received properties; and transmit the processed properties to the framework application, wherein the framework application is configured to perform the pipeline replacement based on the processed properties received from the pipeline switching application.

The framework application may be configured to: collect and store properties for a screen of each pipeline from the plurality of display applications at predetermined intervals; and perform centralized management of each of the pipelines.

The framework application may be a daemon application configured to operate independently of the kernel.

The framework application may be configured to: change properties of a cathode ray tube controller (CRTC) and a connector of the kernel for a first screen to properties of a CRTC and a connector of the kernel for a second screen; and change properties of the CRTC and the connector for the second screen to properties of the CRTC and the connector for the first screen.

The kernel may comprise a Direct Rendering Manager (DRM) configured as a hardware interface to connect image data of the plurality of display applications with the plurality of screens, wherein the DRM comprises: a plane configured as a basic unit for managing the image data; the CRTC configured to convert the image data of the plane into pixel data and output the pixel data to the display device; an encoder configured to encode the pixel data generated by the CRTC; a bridge configured to convert the encoded pixel data into a hardware display interface; and the connector configured as a display output port connected to the display device.

The processor of the multi-display terminal may be further configured to execute the instructions to provide: a back-end module corresponding to each of the plurality of display applications, configured to perform processing to transfer the image data to the DRM, wherein the back-end module is configured to be shared by Graphical User Interface (GUI) modules of the corresponding display application.

According to some embodiments, the present disclosure may enable real-time switching of multi-display devices outputting image data of a plurality of applications.

According to some embodiments, a multi-display terminal mounted in a vehicle may enable real-time screen switching to allow a driver to obtain desired information while driving, thereby improving user convenience.

According to some embodiments, the present disclosure may overcome hardware limitations and cost problems of conventional screen switching.

### BRIEF DESCRIPTION OF THE DRAWINGS

FIG. 1 is a diagram illustrating a configuration of a multi-display terminal according to an embodiment.

FIG. 2 is a diagram illustrating a pipeline replacement operation for the screen switching in FIG. 1.

FIG. 3 is a diagram illustrating an example of screen switching in a multi-display terminal mounted in a vehicle according to an embodiment.

FIG. 4A and FIG. 4B are a flowchart illustrating a screen switching operation of a multi-display terminal according to an embodiment.

### DETAILED DESCRIPTION OF THE EMBODIMENTS

Embodiments of the present disclosure are described in detail with reference to the accompanying drawings so that those of ordinary skill in the art to which the disclosure pertains may easily implement the present disclosure. However, the present disclosure may be implemented in many different forms and is not limited to the embodiments described herein. In the drawings, parts unrelated to the description are omitted for clarity, and similar reference numerals designate similar parts throughout the specification.

In the description, unless explicitly stated to the contrary, the word “comprise” and variations such as “comprises” and “comprising” should be understood to imply the inclusion of stated elements but not the exclusion of any other elements.

Terms such as a “unit”, a “module”, and the like described in the specification may mean a unit for processing at least one function or operation, and may be implemented by hardware, software, or a combination of hardware and software.

In the description, reference numerals and names are attached for convenience of explanation, and the devices are not necessarily limited to the reference numerals or names.

In the present specification, the term “transmit” or “provide” may refer to not only direct transmission or provision but also indirect transmission or provision via another device or a bypass path.

In the present specification, an expression recited in the singular may be construed as singular or plural unless the expression “one”, “single”, etc., is used.

In the present specification, the same reference numerals refer to the same components regardless of the drawings, and the term “and/or” includes any and all combinations of one or more of the associated listed items.

In the present specification, terms including ordinal numbers, such as “first”, “second”, etc., may be used to describe various components, but the components are not limited by such terms. The terms are used only for the purpose of distinguishing one component from another. For example, without departing from the scope of the present disclosure, a first component may be referred to as a second component, and similarly, a second component may be referred to as a first component.

In the flowcharts described with reference to the drawings in the present specification, the order of operations may be changed, several operations may be merged, an operation may be divided, and a specific operation may not be performed.

An apparatus of the present disclosure may be a computing apparatus configured and connected to allow at least one processor to perform an operation of the present disclosure by executing instructions. A computer program may comprise instructions that, when executed by the processor, cause the processor to perform the operation of the present disclosure, and may be stored in a non-transitory computer readable storage medium. The computer program may be downloaded over a network, or may be sold in a form of a product.

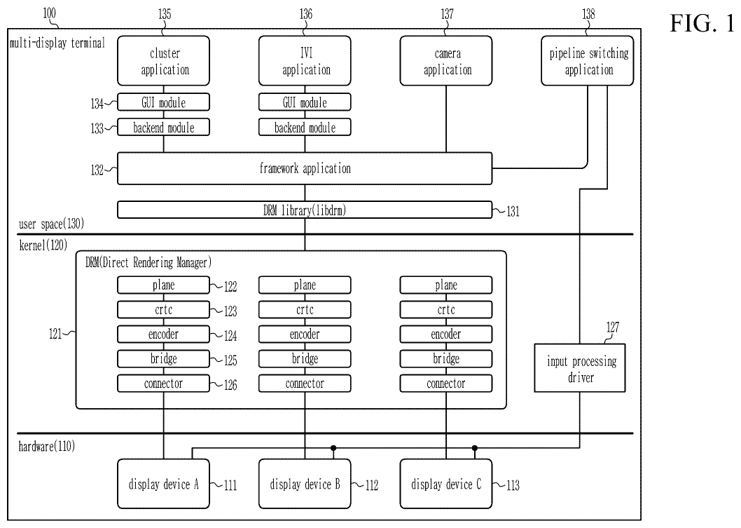

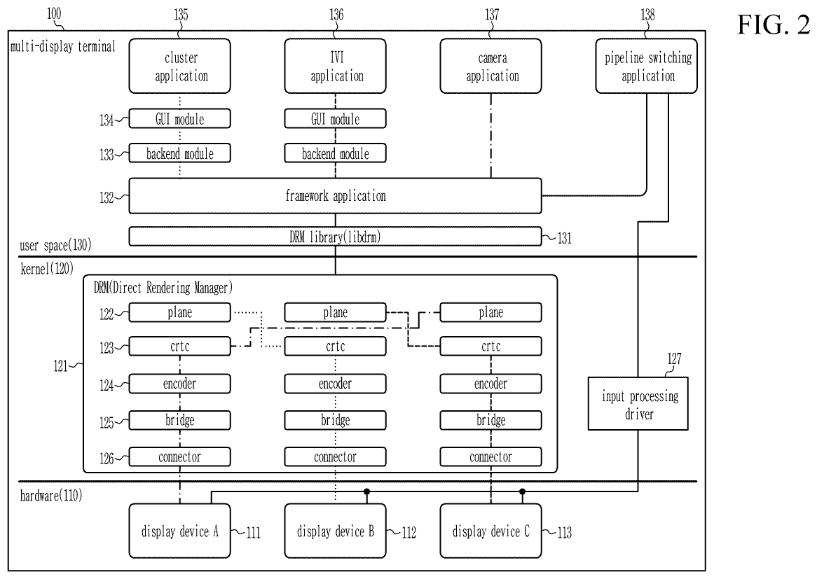

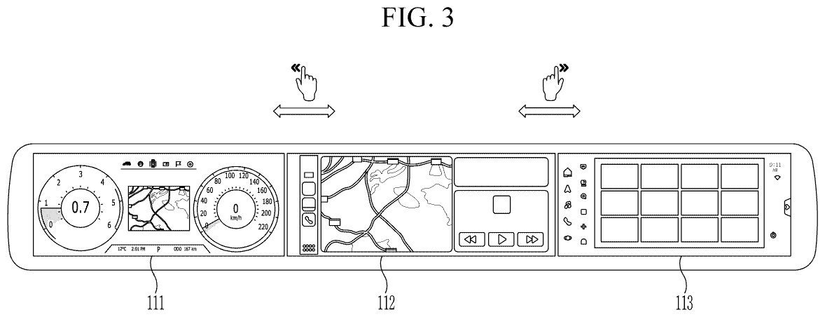

FIG. 1 is a diagram illustrating a configuration of a multi-display terminal according to an embodiment, FIG. 2 is a diagram illustrating a pipeline replacement operation for the screen switching in FIG. 1, and FIG. 3 is a diagram illustrating an example of screen switching in a multi-display terminal mounted in a vehicle according to an embodiment.

A multi-display terminal is a terminal equipped with a plurality of screens.

The multi-display terminal may comprise a plurality of display devices configured to output respective screens. Each display device is coupled to a plurality of different applications via independent pipelines.

A pipeline is configured to perform graphics processing on content data of an application and output the processed content data to a screen.

The multi-display terminal may comprise a single multi-display device configured to output a plurality of screens. An entire display area of the single multi-display device is divided into a plurality of screen areas, and each of the screen areas is coupled to a plurality of different applications via independent pipelines.

The multi-display terminal may comprise at least one display device configured to output an individual screen and at least one multi-display device configured to output a plurality of divided screen areas.

Hereinafter, for convenience of description, a multi-display terminal equipped with a plurality of display devices configured to output individual screens will be described as an example, and such a configuration may be applied to all of the various types of multi-display terminals described above.

Referring to FIG. 1, a multi-display terminal 100 may be configured in a hierarchical structure comprising hardware 110, a kernel 120, and a user space 130.

Although the hardware 110 generally includes a memory for storing instructions, a processor for executing the instructions, an input device, and a display device, for convenience of explanation, the processor, the memory, a storage, and the input device are omitted from the drawing, and only multi-display devices 111, 112, and 113 are illustrated.

The memory of the hardware 110 stores instructions to provide the kernel 120, and the DRM-library 131, the modules 133 and 134, and the applications 132, 135, 136, 137, and 138 of the user space 130. The processor of the hardware 110 is configured to execute the instructions stored in the memory to provide the kernel 120, the DRM-library 131, the modules 133 and 134, and the applications 132, 135, 136, 137, and 138.

The kernel 120 is configured to directly control the hardware 110. A plurality of applications 135, 136, and 137 of the user space 130 are configured to indirectly access the hardware 110 via the kernel 120.

Each of the display devices 111, 112, and 113 is configured to output image data through a respective individual screen. The display devices 111, 112, and 113 may comprise a display function and an input sensing function. For example, each of the display devices 111, 112, and 113 may be implemented as a touch screen device.

The kernel 120 is a memory space configured to manage hardware and system resources, and serves as an area where an operating system kernel (core code) is executed. The kernel 120 is configured to directly interact with the hardware 110 and control a central processing unit (CPU), a memory, and input/output (I/O) devices.

The kernel 120 has full privileges and is isolated and protected from the user space 130. Further, the kernel 120 is configured to process system calls, which are program requests received from the user space 130.

The kernel 120 is configured to process respective image data for output to the display devices 111, 112, and 113.

The kernel 120 may comprise a Direct Rendering Manager (DRM) 121 and an input processing driver 127.

The DRM 121 is a hardware interface configured to connect image data of a plurality of display applications 135, 136, and 137 with the display devices 111, 112, and 113.

The DRM 121 may comprise a plane 122, a cathode ray tube controller (CRTC) 123, an encoder 124, a bridge 125, and a connector 126.

The plane 122 is configured as a basic unit for managing image data (or graphic data) to be output to each screen of the display devices 111, 112, and 113, and is configured to process various image layers, such as a user interface (UI), a video, and the like. The plane 122 is coupled to a specific memory buffer to provide the image data.

The plane 122 may comprises a primary plane, an overlay plane, and a cursor plane. The primary plane is configured to process basic display content. The overlay plane is configured to process additional layers, such as a video, a graphic, and the like. The cursor plane is configured to process user interface (UI) elements such as a mouse cursor.

The CRTC 123 is configured to convert the image data of the plane 122 into pixel data and output the pixel data to the display devices 111, 112, and 113. The CRTC 123 is configured to control display timing, such as a refresh rate and the like.

The CRTC 123 is configured to combine a plurality of planes 122 to configure a screen for output to the display devices 111, 112, and 113.

The CRTC 123 configures display mode settings, such as a resolution, a refresh rate, and the like, and is coupled to a screen output path.

The encoder 124 is configured to convert pixel data generated by the CRTC 123 into a signal suitable for the display devices 111, 112, and 113. The encoder 124 is configured to cooperate with the bridge 125 to transmit the signal, support various display output ports, and set the signal format, such as a digital format, an analog format, and the like. For example, the encoder 124 may support a High Definition Multimedia Interface (HDMI), a DisplayPort, a Video Graphics Array (VGA), and the like.

The bridge 125 is configured to convert display data into a signal for a hardware display interface. The bridge 125 is configured to perform signal conversion and transmission at a final stage of display output and provide compatibility with specific display devices 111, 112, and 113. For example, the hardware display interface may comprise a High Definition Multimedia Interface (HDMI), Low-Voltage Differential Signaling (LVDS), a Display Serial Interface (DSI), and the like.

The connector 126 is coupled to the display devices 111, 112, and 113, which may comprise a monitor, a panel, and the like, and is configured to manage a status of the display devices 111, 112, and 113. Herein, the status of the display devices 111, 112, and 113 may comprise a connection status, reading of extended display identification data (EDID), and the like.

The connector 126 is a physical display output port. The connector 126 may be configured to comprise a plug-and-play function, which is an automatic recognition function performed upon connection of the display devices 111, 112, and 113.

The input processing driver 127 is configured to transfer a screen switching event, which is generated in response to user input, to the pipeline switching application 138.

The user space 130 is an area where a plurality of applications 135, 136, 137, and 138 are executed and is a memory space accessible by general user processes.

In the user space 130, application programs, such as a web browser, a text editor, and the like, are executed. The user space 130 is protected by an operating system, is restricted from directly accessing system resources, and is configured to utilize system calls to communicate with the kernel 120.

The user space 130 may comprise a direct rendering manager (DRM) library (libdrm) 131, a framework application 132, a back-end module 133, a graphic user interface (GUI) module 134, and a plurality of applications 135, 136, 137, and 138.

The direct rendering manager (DRM) library (libdrm) 131 is a user-space library configured to allow a plurality of display applications 135, 136, and 137 to access the DRM 121 in an operating system that supports an input/output control (IOCTL) interface.

The framework application 132 is configured to monitor each pipeline and handle properties.

A single pipeline is configured to connect individual display applications 135, 136, and 137, the GUI module 134, the back-end module 133, the framework application 132, the DRM library 131, components of the DRM, and individual display devices 111, 112, and 113. The components of the DRM comprise the plane 122, the CRTC 123, the encoder 124, the bridge 125, and the connector 126.

Properties are used to manage display components, that is, DRM components, such as the plane 122, the CRTC 123, the encoder 124, the bridge 125, the connector 126.

Primary functions of the properties may comprise setting a position and a size of content, controlling a display mode, managing information of connected display devices, color correction, power management, and the like.

The framework application 132 is positioned between the kernel 120 and a plurality of display applications 135, 136, and 137.

The framework application 132 is configured to collect and store properties for a screen of each pipeline corresponding to the display devices 111, 112, and 113 from the plurality of display applications 135, 136, and 137 at predetermined intervals, and perform centralized management of each of the pipelines.

The framework application 132 is configured to store and manage property information for each pipeline in a resource manager at a predetermined time or a predetermined interval. Herein, the predetermined time or the predetermined interval may comprise at least one of a user-defined interval, 10 ms to 20 ms, 16.6 ms, and the like.

The framework application 132 may be a daemon application configured to operate independently of the kernel 120. Accordingly, because the framework application 132 is capable of operating regardless of the kernel 120, a structure that significantly reduces complexity may be implemented.

The framework application 132 may be configured to perform a pipeline replacement by interchanging at least a portion of the properties between the target screens using properties of the target screens, in response to a screen switching request based on a user input, and to apply property change information on the replaced pipeline to the display devices 111, 112, and 113 corresponding to the target screens.

According to an embodiment, the use of the properties may comprise an utilization operation performed when a screen switching request occurs.

The framework application 132 is DRM driver extension kernel module code and may be configured to perform the utilization operation by using utilization codes for major components of the DRM 121. Examples of the utilization codes may be implemented as shown in Table 1.

```
TABLE 1
#include <linux/module.h>
#include <linux/kernel.h>
#include <linux/init.h>
#include <drm/drm_drv.h>
#include <drm/drm_crtc.h>
static int hook_crtc_helper_funcs(struct drm_crtc *crtc)
{
  if (crtc && crtc->helper_private) {
    const struct drm_crtc_helper_funcs *funcs = crtc->helper_private;
    // Logging of CRTC information
    pr_info(“CRTC %d: mode_fixup=%p, mode_set=%p\n”,
        crtc->base.id, funcs->mode_fixup, funcs->mode_set);
    // Performing required utilization operations herein
  }
  return 0;
}
static int _{——}init drm_hook_init(void)
{
  struct drm_device *dev;
  struct drm_crtc *crtc;
  // Iterating through all DRM devices and CRTCs
  list_for_each_entry(dev, &drm_minor_list, minor_list) {
    list_for_each_entry(crtc, &dev->mode_config.crtc_list, head) {
      hook_crtc_helper_funcs(crtc);
    }
  }
  pr_info(“DRM hook module initialized\n”);
  return 0;
}
static void _{——}exit drm_hook_exit(void)
{
  pr_info(“DRM hook module exited\n”);
}
module_init(drm_hook_init);
module_exit(drm_hook_exit);
MODULE_LICENSE(“GPL”);
MODULE_AUTHOR(“Your Name”);
MODULE_DESCRIPTION(“DRM Hook Module for Automotive Display”);
```

The use of the properties may comprise operations in which the framework application 132 traces DRM function calls and collects necessary information using frace, monitors real-time display information using a debugfs interface, and detects display state changes by implementing a DRM event listener.

According to another embodiment, the use of the properties may comprise operations of storing the properties in the form of a lookup table (LUT) and obtaining corresponding properties from the lookup table (LUT) when a screen switching request occurs. In the lookup table (LUT), the properties for each pipeline may be stored at predetermined intervals.

According to another embodiment, the use of the properties may comprise operations of temporarily storing the properties in a flash memory or the like when a vehicle is started, and calling and using the temporarily stored properties when a screen switching request occurs. In the flash memory, the properties for each pipeline may be stored at predetermined intervals. The properties stored in the flash memory may be deleted when the vehicle is turned off.

The property information used by the framework application 132 is obtained from a resource manager configured to manage properties within the framework application 132.

The framework application 132 may be configured to perform a pipeline replacement based on processed properties received from the pipeline switching application 138.

When a screen switching request is delivered from the pipeline switching application 138, the framework application 132 is configured to perform a pipeline replacement by interchanging a portion of properties of a pipeline for each screen between target screens. The framework application 132 identifies display devices 111, 112, and 113 that output the target screens. The framework application 132 may perform the pipeline replacement using pipeline properties of the identified display devices 111, 112, and 113. Specifically, the framework application 132 changes a portion of properties of a display device A 111 outputting a target screen A to properties of a display device B 112 outputting a target screen B, and changes a portion of properties of the display device B 112 to properties of the display device A 111.

Objects for the property change may comprise the CRTC 123 and the connector 126, while the plane 122 may be maintained.

The framework application 132 may transfer the used properties to the pipeline switching application 138 and receive processed properties therefrom. The framework application 132 may perform the pipeline replacement based on the received processed properties. Specifically, the framework application 132 may be perform the pipeline replacement by changing properties for a CRTC 123 and a connector 126 of a kernel for a first screen into properties for a CRTC 123 and a connector 126 for a second screen, and changing the properties for the CRTC 123 and the connector 126 for the second screen into the properties for the CRTC 123 and the connector 126 for the first screen.

Since the operation of changing a pipeline requires authorization to use the resources of the kernel 120, the framework application 132 may serve as a manager that allocates permissions to the plurality of applications 135, 136, 137, and 138 based on predefined rules.

The framework application 132 may dynamically manage and change all display properties. Since the monitoring and the use of the properties are performed within a single engine by the framework application 132, screen switching can be easily facilitated.

The back-end module 133, serving as a DRM back-end module, may be configured to perform processing for transferring image data of a plurality of display applications 135, 136, and 137 to the DRM 121. The back-end module 133 is connected to each of the display applications 135, 136, and 137, and is attached to the framework application 132.

Conventionally, a backend module allowed a single GUI to exclusively occupy and use a DRM. However, the back-end module 133 of the present disclosure may support the simultaneous use of the DRM 121 with other display applications 135, 136, and 137 by enhancing a pre-implemented DRM backend module (e.g., drm-backend.so). That is, the back-end module 133 is shared by GUI modules 134 of the respective display applications 135, 136, and 137.

The GUI module 134 composites images requested by a plurality of display applications 135, 136, and 137 into a single image. According to an embodiment, the GUI module 134 may comprise a Weston module.

The plurality of applications 135, 136, 137, and 138 comprise the plurality of display applications 135, 136, and 137 and the pipeline switching application 138.

The plurality of display applications 135, 136, and 137 are coupled to the multiple display devices via respective independent pipelines, generate properties which are display settings for individual screens, and output the generated properties to the kernel 120.

In an embodiment where the multi-display terminal 100 is configured as a vehicle-mounted terminal, the display applications 135, 136, and 137 may comprise a cluster application 135, an In-Vehicle Infotainment (IVI) application 136, a camera application 137, and the like.

The cluster application 135 may display autonomous driving operation information, such as an inter-vehicle distance, a lane recognition indicator, a vehicle approach warning, and a pedestrian warning, in addition to in-vehicle cluster information, i.e., basic vehicle information such as RPM, speed, and warnings.

The IVI application 136 may perform functions such as Global Positioning System (GPS) navigation, multimedia entertainment, various user-downloadable applications, voice recognition, and safety diagnostics, and the like.

The camera application 137 may interwork with cameras installed at various locations in the vehicle to process images captured from the inside and/or outside of the vehicle.

The pipeline switching application 138 is an application capable of recognizing a current display status and switching pipelines.

Upon receiving a screen switching request event from the input processing driver 127, the pipeline switching application 138 requests screen switching to the framework application 132. The pipeline switching application 138 receives properties of pipelines subject to screen switching from the framework application 132, processes the received properties, and transfers the processed properties to the framework application 132.

Herein, applications connected to the display devices 111, 112, and 113 via pipelines are referred to as display applications 135, 136, and 137 to be distinguished from the pipeline switching application 138.

Each of the display applications 135, 136, and 137 writes contents to a desired plane (image layer) 122, and performs a display setting operation of selecting a desired display mode and a display device 111, 112, or 113.

The display mode may comprise a resolution, a refresh rate, and the like.

The display setting operation is generated in the form of text-based properties, and the properties serve as information transmitted to the corresponding display devices 111, 112, 113 through a single pipeline.

The framework application 132 monitors and stores all properties. When a screen switching event occurs, the pipeline switching application 138 processes the properties used by the framework application 132 to change pipelines, and provides the processed properties to the framework application 132.

The framework application 132 transmits the processed properties collectively to the kernel 120 via the DRM library 131. The kernel 120 performs pipeline switching based on the transmitted properties, and outputs contents of the respective display applications 135, 136, and 137 to the switched display devices 111, 112, and 113 accordingly.

Referring to FIG. 3, in a state where the display devices 111, 112, and 113 are arranged in a line, a user may switch adjacent screens.

According to an embodiment, when a screen switching request for switching the display device A 111 to the display device B 112 occurs in response to a user input, the CRTC 123 among properties of the cluster application 135 connected to the display device A 111 via a pipeline is changed to the CRTC 123 among properties of the IVI application 136 connected to the display device B 112 via a pipeline. In this manner, the pipeline of the cluster application 135 is changed to the DRM components 122, 123, 124, 125, and 126 connected to the display device B 112. That is, as shown in FIG. 2, the pipeline of the cluster application 135 is configured in the following connection order: ‘cluster application 135-GUI module 134-backend module 133-framework application 132-DRM library 131-plane 122 connected to the display device A 111-CRTC 123 connected to the display device B 112-encoder 124 connected to the display device B 112-bridge 125 connected to the display device B 112-connector 126 connected to the display device B 112-display device B 112’.

Further, when a screen switching request for switching the display device B 112 to the display device C 113 occurs in response to a user input, the CRTC 123 among properties of the IVI application 136 connected to the display device B 112 via a pipeline is changed to the CRTC 123 among properties of the camera application 137 connected to the display device C 113 via a pipeline. In this manner, the pipeline of the IVI application 136 is changed to the DRM components 122, 123, 124, 125, and 126 connected to the display device C 113. That is, as shown in FIG. 2, the pipeline of the IVI application 136 is configured in the following connection order: ‘IVI application 136-GUI module 134-backend module 133-framework application 132-DRM library 131-plane 122 connected to the display device B 112-CRTC 123 connected to the display device C 113-encoder 124 connected to the display device C 113-bridge 125 connected to the display device C 113-connector 126 connected to the display device C 113-display device C 113’.

Likewise, when a screen switching request for switching the display device C 113 to the display device A 111 occurs in response to a user input, the CRTC 123 among properties of the camera application 137 connected to the display device C 113 via a pipeline is changed to the CRTC 123 among properties of the cluster application 135 connected to the display device A 111 via a pipeline. In this manner, the pipeline of the camera application 137 is changed to the DRM components 122, 123, 124, 125, and 126 connected to the display device A 111. That is, as shown in FIG. 2, the pipeline of the camera application 137 is configured in the following connection order: ‘camera application 137-GUI module 134-backend module 133-framework application 132-DRM library 131-plane 122 connected to the display device C 113-CRTC 123 connected to the display device A 111-encoder 124 connected to the display device A 111-bridge 125 connected to the display device A 111-connector 126 connected to the display device A 111-display device A 111’.

Even upon screen switching, the plane 122 of each pipeline may be maintained identical to that prior to the switching. That is, in the pipeline of each of the display applications 135, 136, and 137, the plane connected to the display device prior to the switching remains unchanged. And among the DRM components, from the CRTC to the target display devices are replaced.

As described above, the multi-display terminal 100 monitors properties of the display applications 135, 136, and 137, and when a screen switching event occurs, changes pipelines connected to the target screens to switch and output contents through the switched display screens.

In conventional systems, an operation of changing pipelines may conflict with screen refresh timing, causing problems such as screen lag, blackouts, or flickering. This may cause driver distraction in a vehicular display environment during driving, thereby posing a safety issue. However, according to the pipeline changing operation of the present disclosure, screen switching is performed seamlessly without screen lag or flickering, thereby ensuring driver safety.

Furthermore, Real-time screen switching is possible through a framework application without the need for hardware such as a monitor switcher, at no additional cost. Consequently, the driver can obtain information via a desired screen while driving, and the front passenger can also switch a desired screen to a desired location. For instance, it is possible to perform real-time screen switching, such as keeping the cluster screen primarily within the driver's field of view while driving, and temporarily placing the infotainment screen in the driver's field of view when the vehicle is stopped or when necessary, before returning it to its original position.

According to the present disclosure, the proposed scheme may be commercialized as a software-based solution replacing a hardware-based screen switcher (e.g., a monitor switcher), and may be provided as a cost-reduction solution to vehicle manufacturers and automotive software developers. Furthermore, it is possible to develop automotive software that allows a driver and a front passenger to individually switch screens or configure information in a customized manner.

Based on the configuration described above, operations of the multi-display terminal 100 will be described below. Herein, the same reference numerals are used for the same components, and redundant descriptions thereof may be omitted.

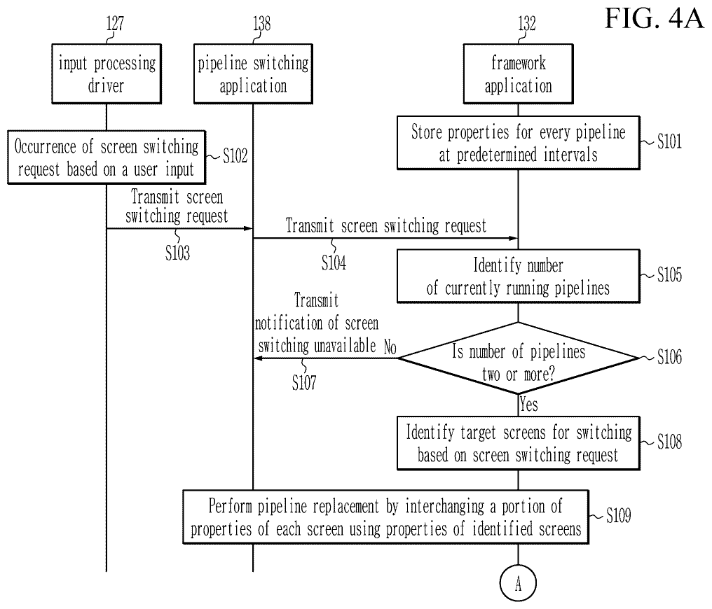

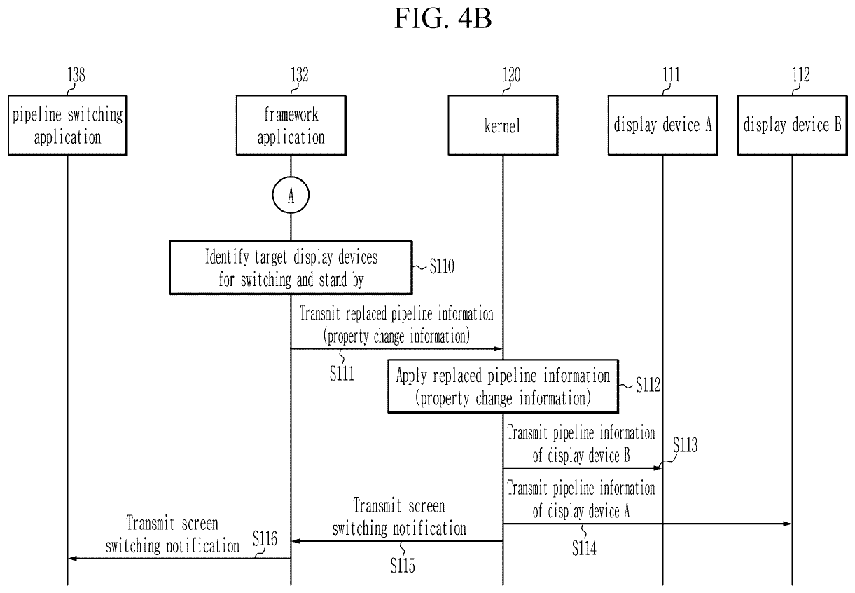

FIG. 4A and FIG. 4B are a flowchart illustrating a screen switching operation of a multi-display terminal according to an embodiment.

In this example, the display device A 111 and the display device B 112 are taken as examples of the target display devices for screen switching.

Referring to FIG. 4A, the framework application 132 stores properties for every pipeline at predetermined intervals (S101). That is, the framework application 132 may collect and store properties of screens output by the display devices 111, 112, and 113 of the respective pipelines from the plurality of display applications 135, 136, and 137 connected to the display devices 111, 112, and 113 outputting individual screens via independent pipelines.

When a screen switching request based on a user input occurs (S102), the input processing driver 127 generates an event requesting screen switching and transmits the generated event to the pipeline switching application 138 (S103).

The pipeline switching application 138 transmits the screen switching request to the framework application 132 (S104).

The framework application 132 identifies the number of currently running pipelines (S105) and determines whether the number of pipelines is two or more (S106).

If the number of pipelines is not two or more, the framework application 132 transmits a notification indicating that screen switching is impossible to the pipeline switching application 138 (S107).

If the number of pipelines is two or more, the framework application 132 identifies target screens for switching based on the screen switching request (S108).

The framework application 132 performs pipeline replacement by interchanging at least a portion of properties of each screen using the properties of the identified screens (S109). In step S109, the framework application 132 transmits the used properties to the pipeline switching application 138, receives properties processed by the pipeline switching application 138, and performs the pipeline replacement based on the received properties.

Referring to FIG. 4B, the framework application 132 checks target display devices for switching according to the screen switching request and stands by (S110).

The framework application 132 transmits replaced pipeline information, that is, property change information of the replaced pipelines, to the kernel 120 (S111).

The kernel 120 applies the replaced pipeline information to each pipeline, that is, the DRM 121 (S112). That is, as described with reference to FIG. 2, pipelines are replaced according to the CRTC 123 and the connector 126 whose properties have been replaced, except for the plane 122.

The kernel 120 transmits pipeline information of the display device B to the display device A 111, and transmits pipeline information of the display device A to the display device B 112 (S113 and S114). That is, pipelines connected to the display device A 111 and the display device B 112 are swapped according to the property change information.

In step S113, the pipeline of the IVI application 136 is changed to the DRM components 123, 124, 125, and 126 connected to the display device A 111, and in step S114, the pipeline of the cluster application 135 is changed to the DRM components 123, 124, 125, and 126 connected to the display device B 112.

When the pipeline replacement operation is completed, the kernel 120 transmits a screen switching notification to the framework application 132 (S115).

The framework application 132 transmits the screen switching notification to the pipeline switching application 138 (S116).

According to an embodiment, the pipeline switching application 138 may display a screen switching success message as a pop-up on the screens of the switched display devices 111 and 112.

The embodiments of the present disclosure described above are not implemented only through devices and methods, but may also be implemented through a program that realizes a function corresponding to the configuration of the embodiments of the present disclosure or a recording medium on which the program is recorded.

While this disclosure has been described in connection with what is presently considered to be practical embodiments, it should be understood that the disclosure is not limited to the disclosed embodiments, but, on the contrary, is intended to cover various modifications and equivalent arrangements included within the spirit and scope of the appended claims.

What is claimed is:

1. A method for operating a multi-display terminal equipped with a plurality of screens, the method comprising:
replacing a pipeline by interchanging at least a portion of properties between target screens using the properties of the target screens, in response to a screen switching request based on a user input; and
applying property change information on the replaced pipeline to the target screens.

2. The method of claim 1, wherein the replacing the pipeline comprises
changing properties of a cathode ray tube controller (CRTC) and a connector of a kernel for a first screen to properties of a CRTC and a connector of the kernel for a second screen, and changing properties of the CRTC and the connector for the second screen to properties of the CRTC and the connector for the first screen.

3. The method of claim 2, further comprising:
prior to the replacing the pipeline, collecting and storing properties for a screen of each pipeline from a plurality of display applications coupled to the plurality of screens via respective independent pipelines.

4. The method of claim 3, wherein the replacing the pipeline, and the collecting and storing the properties are performed by a framework application positioned between the plurality of display applications and the kernel.

5. The method of claim 4, wherein the replacing the pipeline comprises:
providing, by the framework application, properties of target pipelines for switching to a pipeline switching application having detected the screen switching request, in response to a request from the pipeline switching application;
receiving, by the framework application, processed properties from the pipeline switching application; and
replacing the pipeline based on the processed properties.

6. A multi-display terminal comprising:
at least one display device configured to output a plurality of screens;
a memory configured to store instructions; and
a processor configured to execute the instructions to provide:
a kernel configured to process image data to be output to the plurality of screens;
a plurality of display applications coupled to the plurality of screens via respective independent pipelines, wherein each of the plurality of display applications is configured to generate a property including a display setting for a corresponding screen and output the property to the kernel; and
a framework application positioned between the kernel and the plurality of display applications,
wherein the framework application is configured to:
perform a pipeline replacement by interchanging at least a portion of properties between target screens using the properties of the target screens, in response to a screen switching request based on a user input; and
apply property change information on the replaced pipeline to the target screens.

7. The multi-display terminal of claim 6, wherein the processor is further configured to execute the instructions to provide a pipeline switching application configured to:
detect the screen switching request;
receive, from the framework application, properties of target pipelines for the screen switching request and process the received properties; and
transmit the processed properties to the framework application,
wherein the framework application is configured to perform the pipeline replacement based on the processed properties received from the pipeline switching application.

8. The multi-display terminal of claim 7, wherein the framework application is configured to:
collect and store properties for a screen of each pipeline from the plurality of display applications at predetermined intervals; and
perform centralized management of each pipeline.

9. The multi-display terminal of claim 8, wherein the framework application is a daemon application configured to operate independently of the kernel.

10. The multi-display terminal of claim 7, wherein the framework application is configured to:
change properties of a cathode ray tube controller (CRTC) and a connector of the kernel for a first screen to properties of a CRTC and a connector of the kernel for a second screen; and
change properties of the CRTC and the connector for the second screen to properties of the CRTC and the connector for the first screen.

11. The multi-display terminal of claim 10, wherein the kernel comprises a Direct Rendering Manager (DRM) configured as a hardware interface to connect image data of the plurality of display applications with the plurality of screens,
wherein the DRM comprises:
a plane configured as a basic unit for managing the image data;
the CRTC configured to convert the image data of the plane into pixel data and output the pixel data to the display device;
an encoder configured to encode the pixel data generated by the CRTC;
a bridge configured to convert the encoded pixel data into a hardware display interface; and
the connector configured as a display output port connected to the display device.

12. The multi-display terminal of claim 11, wherein the processor is further configured to execute the instructions to provide:
a back-end module corresponding to each of the plurality of display applications, configured to perform processing to transfer the image data to the DRM,
wherein the back-end module is configured to be shared by Graphical User Interface (GUI) modules of the corresponding display application.
